(19) United States
(12) Patent Application Publication
(10) Pub. No.: US 2015/0120991 A1
(43) Pub. Date: Apr. 30, 2015

(54) DATA PROCESSING SYSTEM AND OPERATING METHOD THEREOF

(71) Applicant: SK hynix Inc., Gyeonggi-do (KR)

(72) Inventors: Hui Won LEE, Gyeonggi-do (KR); Eu Joon BYUN, Gyeonggi-do (KR); Yun Chan SEO, Gyeonggi-do (KR); Hoe Seung JUNG, Gyeonggi-do (KR)

(73) Assignee: SK hynix Inc., Gyeonggi-do (KR)

(21) Appl. No.: 14/144,008

(22) Filed: Dec. 30, 2013

(30) Foreign Application Priority Data
Oct. 31, 2013 (KR) 10-2013-0130736

(51) Int. Cl. G06F 3/06

(52) U.S. Cl. CPC G06F 3/0625; G06F 3/0679; G06F 3/0655; G06F 2206/1014
USPC 711/103

(57) ABSTRACT

A data processing system includes a host device comprising an application and suitable for generating information on an attribute of the application and providing the information on the attribute of the application together with a request of the application and a data storage device suitable for writing data based on the information on the attribute of the application in response to the request of the application.

### CROSS-REFERENCES TO RELATED APPLICATION

The present application claims priority under 35 U.S.C. §119(a) to Korean application number 10-2013-0130736, filed on Oct. 31, 2013, in the Korean Intellectual Property Office, which is incorporated herein by reference in its entirety.

### BACKGROUND

1. Technical Field

Various exemplary embodiments relate to a data processing system, and more particularly, to a method for rapidly processing a write operation.

2. Related Art

A nonvolatile memory device may retain stored data even when a power supply is shut off. Examples of nonvolatile memory devices include a flash memory device, such as a NAND flash memory device or a NOR flash memory device, a ferroelectrics Random Access Memory (FRAM), a Phase-Change Random Access Memory (PRAM), a Magnetic Random Access Memory (MRAM), or a Resistive Random Access Memory (RRAM).

A data storage device including a nonvolatile memory device may receive a write request or a read request with respect to the nonvolatile memory device from an external device. An operating method of a data storage device for efficiently performing a write operation and a read operation with respect to the nonvolatile memory device in response to a request of an external device is in demand.

### SUMMARY

A data processing system capable of rapidly processing a write operation and an operating method thereof are described herein.

In an exemplary embodiment of the present invention, an operating method of a data processing system includes providing information on an attribute of an application together with a request of the application, and processing data based on the information on the attribute of a application in response to a request of the application.

In an exemplary embodiment of the present invention, a data processing system includes a host device comprising an application and suitable for generating information on an attribute of the application and providing the information on the attribute of the application together with a request of the application, and a data storage device suitable for writing data based on the information on the attribute of the application in response to the request of the application.

In an exemplary embodiment of the present invention, a data processing system includes a host device suitable for managing attribute information representing whether an application is strong or weak on a write attribute, and a data storage device suitable for storing data based on the attribute information in response to a write request of the application.

### BRIEF DESCRIPTION OF THE DRAWINGS

Features, aspects, and embodiments are described in conjunction with the attached drawings, in which:

FIG. 1 is a block diagram illustrating the configuration of a Jo data processing system according to an embodiment of the present invention;

FIG. 2 is a view explaining a method for determining the attributes of applications in a file system of FIG. 1;

FIG. 3 is a view illustrating attribute information of an application which is stored in an attribute information register;

FIG. 4 is a flowchart explaining an operating method of the data processing system of FIG. 1; and

FIG. 5 is a block diagram illustrating the configuration of a memory device of FIG. 1.

### DETAILED DESCRIPTION

Hereinafter, a data processing system and an operating method thereof according to the present invention will be described below with reference to the accompanying drawings through exemplary embodiments. Throughout the disclosure, reference numerals correspond directly to the like numbered parts in the various figures and embodiments of the present invention. In addition, a singular form may include a plural form as long as it is not specifically mentioned in a sentence.

FIG. 1 is a block diagram illustrating the configuration of a data processing system according to an embodiment of the present invention.

A data processing system 10 may include a host device 100 and a data storage device 200. The host device 100 may be an electronic device, such as a computer, a notebook computer, a personal digital assistant (PDA), a smart phone, an MP3 player, a digital television set, a digital camera, or the like.

The host device 100 may include a central processing unit 101 and an operation memory unit 102. The central processing unit 101 may control the entire operation of the host device 100. The central processing unit 101 may drive an application APP and a file system 120 on the operation memory unit 102 when a power is applied to the data processing system 10. According to an embodiment of the present invention, the host device 100 may mange the attribute information of the application APP through the file system 120.

The application APP may perform a specific task based on an operation of a user. The application APP may be a set of programs configured to perform a specific task. The application APP may be provide the data storage device 200 with a write request or a read request in order to perform a specific task.

The attribute of the application APP may be determined depending on what operation request mainly provided from the application APP to the data storage device 200. In detail, when a write request is mainly provided to the data storage device 200, the application APP may be determined to be strong in the write attribute. In contrast, when a write request is not mainly provided to the data storage device 200, the application APP may be determined to be weak in the write attribute. This will be described below in detail.

Although FIG. 1 illustrates a case where one application APP is driven, the central processing unit 101 may drive a plurality of applications configured to perform different tasks.

The file system 120 may determine the attribute of the application APP. The file system 120 may generate information is (hereinafter, referred to as “attribute information”) on the attribute of the application APP. The file system 120 may store and manage the attribute information of the application APP in an attribute information register 124. The file system 120 may provide a write request, together with the attribute information of the application APP stored in the attribute information register 124, to the data storage device 200 when the write request is issued by the application APP.

The data storage device 200 may include a controller 210 and a nonvolatile memory device 220.

The controller 210 may control the entire operation of the data storage device 200. The controller 210 may control the operation of the data storage device 200 in response to an operation request of the host device 100. The controller 210 may control data to be written in the nonvolatile memory device 220 in response to a write request of the host device 100. The controller 210 may control data to be read from the nonvolatile memory device 220 in response to a read request of the host device 100. The controller 210 may control a write operation or a read operation with respect to the nonvolatile memory device 220 through control signals, such as a command, an address and the like.

The nonvolatile memory device 220 may include a first memory region 222 and a second memory region 224. The first memory region 222 and the second memory region 224 may be configured with cell arrays which include a plurality of cells. The first memory region 222 and the second memory region 224 may have different cell characteristics. For example, the second memory region 224 may be configured with cells which have a higher program speed than those of the first memory region 222. For example, the second memory region 224 may be configured with single level cells (SLCs) capable of storing 1-bit data per cell, while the first memory region 222 may be configured with multi-level cells (MLCs) capable of storing two or more-bit data per cell.

Since the multi-level cell (MLC) has a large number of threshold voltage values to store multi-bit data, a write operation is to be performed to form an accurate threshold voltage value. Therefore, the multi-level cell (MLC) has a lower program speed than the single level cell (SLC). When the first memory region 222 and the second memory region 224 are configured as above, the second memory region 224 having a higher program speed than the first memory region 222 may be a more efficient region than the first memory region 222 on a write operation.

Although FIG. 1 illustrates the case where the first memory region 222 and the second memory region 224 are included in one nonvolatile memory device, the first memory region 222 and the second memory region 224 may be included in separate nonvolatile memory devices, respectively. In this case, the separate nonvolatile memory devices may be the same type of nonvolatile memory devices, or different types of nonvolatile memory devices. For example, the first memory region 222 may be included in a NAND flash memory, and the second memory region 224 may be included in a ferroelectrics Random Access Memory (FRAM), a Phase-Change Random Access Memory (PRAM), a Resistive Random Access Memory (RRAM), or a Spin Transfer Torque-Magnetic RAM (STT-MRAM), which has a higher program speed than the NAND flash memory.

When the data storage device 200 store data in response to a write request of the host device 100, it makes reference to the attribute information of an application APP provided from the host device 100. In detail, the controller 210 may determine which of the first memory region 222 and the second memory region 224 data is stored in depending on the attribute information of an application APP.

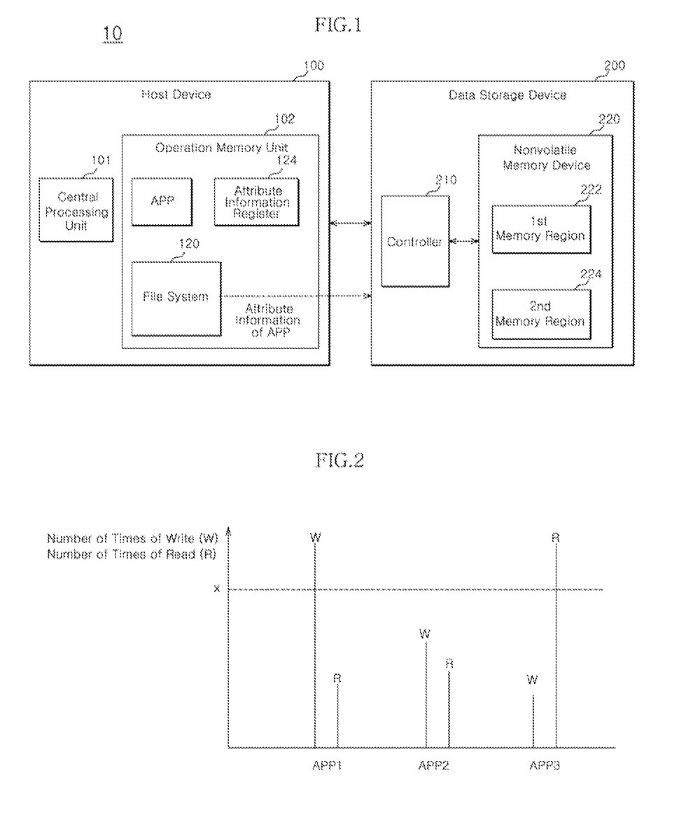

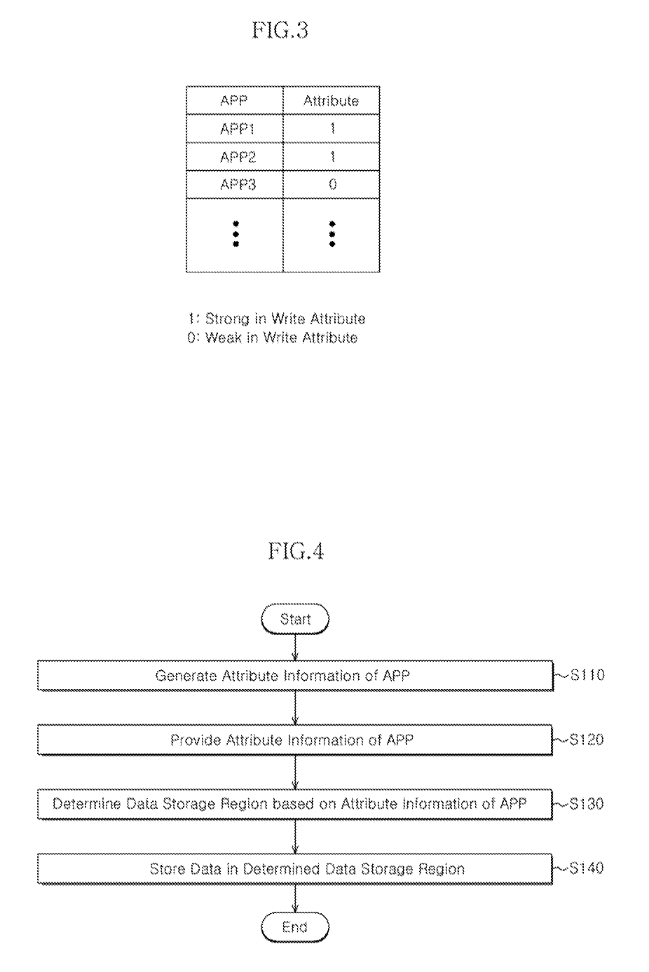

FIG. 2 is a view explaining a method of determining the attributes of applications in the file system of FIG. 1. A first application APP1, a second application APP2 and a third application APP3 in FIG. 2 may be applications, which are driven on the operation memory unit 102 of FIG. 1 by the central processing unit 101 of FIG. 1. The first application APP1, the second application APP2 and the third application APP3 may perform different tasks. Referring to FIG. 2, shown is a method in which the file system 120 of FIG. 1 determines the write attribute of each of the applications APP1, APP2 and APP3 to be strong or weak by making reference to the number of times of Jo write requests and the number of times of read requests of the applications APP1, APP2 and APP3.

The file system 120 may determine the attribute of each of the applications APP1, APP2 and APP3 based on the characteristics of operation requests of the applications APP1, APP2 and APP3. The characteristics of operation requests of the applications APP1, APP2 and APP3 may be determined based on the number of times of write requests, which are provided from each of the applications APP1, APP2 and APP3 to the data storage device 200 of FIG. 1. In detail, the file system 120 may count the number of times of write requests by the applications APP1, APP2 and APP3. The file system 120 may determine the attribute of each of the applications APP1, APP2 and APP3 by making reference to the number of times of write requests. In an example to be described later, the file system 120 may count the number of times of read requests of the applications APP1, APP2 and APP3. In this case, the file system 120 may determine the attribute of each of the applications APP1, APP2 and APP3 by making reference to the number of times of write requests and the number of times of read requests.

For example, the file system 120 may determine whether the number of times of write requests by an application is relatively larger than the number of times of write requests by another application. That is to say, when the numbers of times of write requests by the applications APP1, APP2 and APP3 are arranged in descending order, it may be determined what application belongs to a high set rank. Referring to FIG. 2, the file system 120 may determine that the numbers of times of write requests is decreased in order of the first application APP1, the second application APP2 and the third application APP3. In this case, the file system 120 may determine that the first application APP1 issuing write requests the largest number of times is strong in the write attribute, and the second application APP2 and third application APP3 are weak in the write attribute. Otherwise, the file system 120 may determine that the first application APP1 and the second application APP2 are strong in the write attribute, and the third application APP3 is weak in the write attribute.

In another example, the file system 120 may determine what application issues write requests a predetermined number of times or more. Referring to FIG. 2, the file system 120 may determine that the number of times of write requests by the first application APP1 is equal to or larger than a predetermined number of times “x”, and the numbers of times of write requests by the second application APP2 and third application APP3 are smaller than the predetermined number of times “x”. In this case, the file system 120 may determine that the first application APP1 is strong in the write attribute, and the second application APP2 and third application APP3 are weak in the write attribute.

In further example, the file system 120 may determine whether the number of times of write requests by an application is relatively larger than the number of times of read requests of the application. Referring to FIG. 2, the file system 120 may determine that the numbers of times of write requests by the first application APP1 and second application APP2 are relatively larger than the numbers of times of read requests thereof, respectively, and the number of times of write requests by the third application APP3 is relatively smaller than the number of times of read requests thereof. In this case, the file system 120 may determine that the first application APP1 and second application APP2 are strong in the write attribute, and the third application APP3 is weak in the write attribute.

An application APP, such as a word processing program, may perform a task of writing and correcting a word file. The word processing program may provide the data storage device 200 mainly with write requests on a word file. According to the method for determining the attribute of an application APP, described above, the word processing program may be determined to be strong in the write attribute. An application APP, such as a media player, may perform a task of playing an audio file or a video file. The media player may provide the data storage device 200 mainly with read requests on an audio file or a video file. According to the determination method described above, the media player may be determined to be weak in the write attribute.

FIG. 3 is a view illustrating attribute information of an application, which is stored in the attribute information register of FIG. 3.

The file system 120 of FIG. 1 may generate and store attribute information of the application APP of FIG. 1 in the attribute information register 124 of FIG. 1. For example, the file system 120 may store attribute information of an application APP as “1” when the application APP is strong in the write attribute. In addition, the file system 120 may store attribute information of an application APP as “0” when the application APP is weak in the write attribute. The file system 120 may maintain and manage the attribute information of applications APPs stored in the attribute information register 124. Thereafter, when a write request is issued by a specific application APP, the file system 120 may provide attribute information of the specific application APP to the data storage device 200 by making reference to the attribute information register 124.

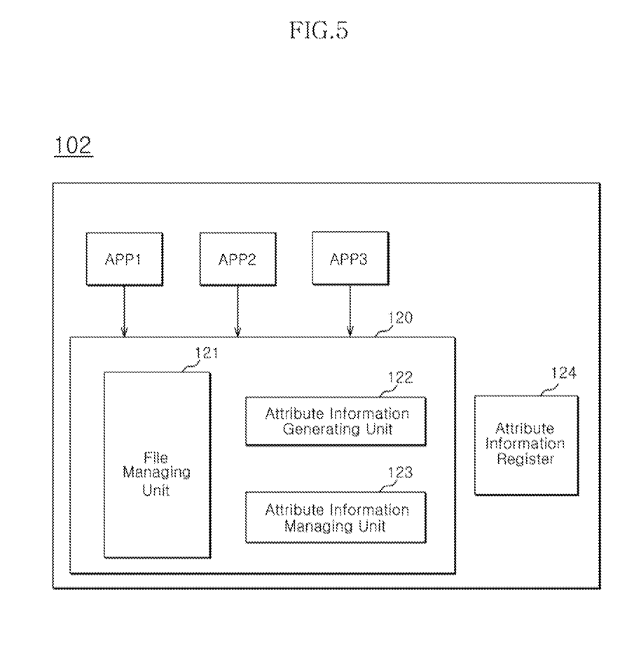

FIG. 4 is a flowchart explaining the operating method of the data processing system of FIG. 1.

In step S110, the file system 120 of FIG. 1 may generate attribute information of the application APP of FIG. 1. In order to generate attribute information of the application APP, the file system 120 may count the number of times of write request and/or the number of times of read requests of the application APP with respect to the data storage device 200 of FIG. 1. The file system 120 may determine attribute information of the application APP by making reference to the number of times of write request and/or the number of times of read requests. The file system 120 may store attribute information of the application APP in the attribute information register 124 of FIG. 1.

In step S120, when a write request is issued by the application APP, the file system 120 may provide the attribute information of the application APP to the data storage device 200. Whenever a write request is issued by the application APP, the file system 120 may provide the attribute information of the application APP, which has been stored in the attribute information register 124. The file system 120 may provide the attribute information of the application APP, together with a write request.

In step S130, the controller 210 may determine a region in which data is to be stored based on the attribute information of the application APP. For example, when the application APP is strong in the write attribute, the controller 210 may determine data to be stored in the second memory region 224.

An application APP, which is strong in the write attribute, may provide write requests more than read requests. For example, an application APP, which is strong in the write attribute, may provide a second write request immediately after providing a first write request. When the second memory region 224 may have a higher program speed than the first memory region 222, the data storage device 200 may rapidly perform a write operation for the first write request on the second memory region 224. The data storage device 200 may rapidly perform even a write operation for the second write request, which is provided immediately after the first write request, on the second memory region 224.

In another example, when the application APP is weak in the Jo write attribute, the controller 210 may determine data to be stored in the first memory region 222.

In step S140, the controller 210 may store data. The controller 210 may store data in a memory region determined in step S130 in response to a received write request.

FIG. 5 is a block diagram illustrating the configuration of a memory unit of FIG. 1. Referring to FIG. 5, illustrated are applications APP1, APP2 and APP3 driven on an operation memory unit 102, a file system 120, and an attribute information register 124 included in the operation memory unit 102.

The applications APP1, APP2 and APP3 of FIG. 5 may be applications, which are driven on the operation memory unit 102 by the central processing unit 101 of FIG. 1. The applications APP1, APP2 and APP3 may perform different tasks. In order to the respective tasks, the applications APP1, APP2 and APP3 may provide operation requests to the data storage device 200 of FIG. 1.

The file system 120 may include a file managing unit 121, an attribute information generating unit 122, and an attribute information managing unit 123.

The file managing unit 121 may manage a variety of files used by the host device 100 of FIG. 1. The file managing unit 121 may manage and systematize files, which relate to operation requests received from the applications APP1, APP2 and APP3. For example, the file managing unit 121 may name files based on a determined rule, and to manage the files with the names. For example, the file managing unit 121 may set a directory structure of files. For example, the file managing unit 121 may manage files in units of sectors.

The attribute information generating unit 122 may generate the attribute information of each of the applications APP1, APP2 and APP3 through operation requests received from the applications APP1, APP2 and APP3. The attribute information generating unit 122 may count the number of times of write requests and/or the number of times of read requests of each of the applications APP1, APP2 and APP3, which are provided to the data storage device 200, in order to generate the attribute information of the applications APP1, APP2 and APP3. The attribute information generating unit 122 may determine attribute information of the applications APP1, APP2 and APP3 by making reference to the counted number of times of write requests and/or the counted number of times of read requests.

The attribute information managing unit 123 may store attribute information of the applications APP1, APP2 and APP3 in the attribute information register 124. The attribute information managing unit 123 may maintain and manage the attribute information of the applications APP1, APP2 and APP3, which has been stored in the attribute information register 124. The attribute information managing unit 123 may provide attribute information of a specific application to the data storage device 200 when the specific application issues a write request.

The file system 120 may be configured based on the operation system of the host device 100. For example, when the operation system of the host device 100 is implemented with DOS or WINDOWS, the file system may be configured with a file allocation table (FAT) file system, a virtual FAT (VFAT) file system, an extended FAT (exFAT) file system, a new technology file system (NTFS), or the like. In another example, when the operation system of the host device 100 is implemented with LINUX, the file system may be configured with an extended file system 2 (ext2), an extended file system 3 (ext3), or the like.

The data processing system according to an embodiment of the present invention may rapidly process a write operation.

While certain embodiments have been described above, it will be understood to those skilled in the art that the embodiments described are by way of example only. Accordingly, the system and method described herein should not be limited based on the described embodiments. Rather, the system and method described herein should only be limited in light of the claims that follow.

What is claimed is:

1. A data processing system comprising:
a host device comprising an application and suitable for generating information on an attribute of the application and providing the information on the attribute of the application together with a request of the application; and
a data storage device suitable for writing data based on the information on the attribute of the application in response to the request of the application.

2. The system according to claim 1, wherein the host device further comprises a file system suitable for generating the information on the attribute of the application and providing the information together with a write request of the application; and
the data storage device comprises first and second memory regions and stores the data in one of the first and second memory regions based on the information in response to the write request of the application.

3. The system according to claim 2, wherein the file system comprises:
an attribute information generating unit suitable for generating the Information on the attribute of the application through the request of the application; and
an attribute information managing unit suitable for providing the information on the attribute of the application to the data storage device.

4. The system according to claim 3, wherein the host device further comprises an attribute information register suitable for storing the Information on the attribute of the application therein.

5. The system according to claim 3, wherein the attribute information generating unit is suitable for counting the number of times of write requests, which are provided to the data storage device by the application, and determining the attribute of the application based on the number of times of write requests.

6. The system according to claim 5, wherein the attribute information generating unit is suitable for determining the application to be strong in a write attribute when the number of times of write requests by the application is equal to or larger than a set number of times.

7. The system according to claim 3, wherein the attribute information generating unit is suitable for counting the number of times of write requests and the number of times of read requests by the application, and determining the attribute of the application based on the number of times of write requests and the number of times of read requests.

8. The system according to claim 7, wherein the attribute information generating unit is suitable for determining the application to be strong in a write attribute when the number of times of write requests by the application is larger than the number of times of read requests thereby.

9. The system according to claim 1, wherein the information on the attribute of the application relates to whether the application is strong or weak in a write attribute.

10. The system according to claim 9, wherein the data storage device is suitable for storing the data in the second memory region when the application is strong in the write attribute.

11. A data processing system comprising:
a host device suitable for managing attribute information representing whether an application is strong or weak on an write attribute; and
a data storage device suitable for storing data based on the attribute information in response to a write request of the application.

12. The system according to claim 11, wherein the host device comprises a file system suitable for generating the attribution information of the application.

13. The system according to claim 12, wherein the file system is suitable for counting the number of times of write requests, which are provided to the data storage device by the application, and determining the attribute of the application based on the number of times of write requests.

14. The system according to claim 13, wherein the file system Jo is suitable for determining the application to be strong in the write attribute when the number of times of write requests by the application is equal to or larger than a set number of times.

15. The system according to claim 12, wherein the file system is suitable for counting the number of times of write requests and the number of times of read requests, which are provided to the data storage device by the application, and determining the attribute of the application based on the number of times of write requests and the number of times of read requests.

16. The system according to claim 15, wherein the file system is suitable for determining the application to be strong in a write attribute when the number of times of write requests by the application is larger than the number of times of read requests thereby.

17. The system according to claim 12, wherein the file system is providing the attribute information to the data storage device in response to the write request of the application.

18. The system according to claim 11, wherein the host device further comprises an attribute information register suitable for storing the information on the attribute of the application therein.

19. The system according to claim 11, wherein the data storage device comprises first and second memory regions, wherein the second memory region is suitable for having a higher program speed than the first memory region.

20. The system according to claim 19, wherein the data storage device stores the data in one of the first and second memory regions based on the information in response to the write request of the application.
